(19) United States
(12) Patent Application Publication
(10) Pub. No.: US 2026/0181449 A1
(43) Pub. Date: Jun. 25, 2026

(54) METHOD FOR SELECTING A PRECODER BASED ON MEASURED SRS INTERFERENCE ON SRS TRANSMITTED BY DOWNLINK HEAVY TRAFFIC USER EQUIPMENTS

(71) Applicant: Telefonaktiebolaget LM Ericsson (publ), Stockholm (SE)

(72) Inventors: Kristina HESSLER, Linkoping (SE); Martin HESSLER, Linkoping (SE)

(21) Appl. No.: 19/126,604

(22) PCT Filed: Nov. 7, 2022
(86) PCT No.: PCT/SE2022/051035

§ 371 Date: May 1, 2025

(51) Int. Cl. H04W 24/10; H04L 5/00; H04W 72/23

(52) U.S. Cl. CPC H04W 24/10; H04L 5/0051; H04W 72/23

(57) ABSTRACT

A method performed by a first network node is provided. The method is for handling Sounding Reference Signal, SRS, configurations in a wireless communications network. The first network node is comprised in a group of network nodes together with one or more second network nodes. The first network node shares (202) a set of SRS configurations in the group of network nodes. The set of SRS configurations comprises SRS resources to be used for SRS interference measurements. The set of SRS configurations is to be used by the network nodes in the group of network nodes to configure User Equipments, UEs. The UEs to be configured are UEs that are identified to be Downlink, DL, heavy traffic UEs comprising DL data, which has an estimated download time that exceeds a threshold. When the first network node obtains (203) data to be transmitted to a first UE, it measures (204) SRS interference. The SRS interference is measured on SRS transmitted by each respective UE identified to be a DL heavy traffic UE by the respective one or more second network nodes. The respective measuring of 15SRS interference is performed on resources according to an SRS configuration out of said shared SRS configuration set. The first network node then selects (205) a precoder for the data to be transmitted to the first UE, based on the measured SRS interference.

### TECHNICAL FIELD

Embodiments herein relate to a first network node, a second network node and methods therein. In some aspects, they relate to handling Sounding Reference Signal (SRS) configurations in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHZ. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

A precoding selection when used herein e.g. means to decide which precoding, or weighting, to apply to the transmitted signal. Reciprocity-based precoding when used herein e.g. means to do the precoding selection based on uplink signals, typically sounding reference signals, by utilizing that uplink and downlink channels are reciprocal in a Time-Division Duplexing (TDD) system.

Two methods for performing reciprocity-based precoding selection in TDD are Reciprocity-Assisted Transmission (RAT) and Reciprocity-Assisted Interference-aware Transmission (RAIT) also referred to as Interference Sensing. In both RAIT and RAT the precoding selection in a base station is done based on measurements on SRS. In RAT, the base station measures on SRS from a UE, or the UEs in case of MU MIMO, it is intending to transmit data to and makes a precoding selection that maximizes the Signal to Interference Noise Ratio (SINR) of this UE or UEs without considering the impact on the SINR of users in other cells. SINR is a measure of signal quality. This precoding selection may result in a lot of interference in neighboring cells. In RAIT, the base station also measures the SRS interference from neighboring cells and takes that interference into account in the precoding selection. The RAIT selected precoding may result in lower interference in neighboring cells in comparison to the RAT selected precoding.

The base station configures the UE with resources that the UE shall use for the SRS transmission. The configuration may comprise selected comb and cyclic shift and in case of periodic SRS transmission timing offset and period. In case of aperiodic SRS the base station triggers one SRS transmission using an SRS request flag in an uplink grant message or in a downlink assignment message. Comb when used herein e.g. means which subcarriers, frequency resource units, to use. Cyclic shifts when used herein e.g., means orthogonal versions of Zadoff-Chu sequence enabling multiple UEs to be multiplexed on the same time and frequency resources.

One existing solution to how to decide on when and on which SRS resources UEs should transmit SRS is to let all users transmit SRS periodically using a configured comb, cyclic shift, period and timing offset. Another solution is to trigger aperiodic SRS transmissions using downlink assignments or uplink grants on a configured comb and cyclic shift.

### SUMMARY

As a part of developing embodiments herein a problem was identified by the inventors and will first be discussed.

In both the above mentioned existing solutions, base stations may measure interference on all available SRS resources. To get good gains with RAIT compared to RAT, a good match between UEs transmitting SRS in the uplink slots and UEs where data is transmitted to in subsequent downlink slots is required. If there are more UEs or other UEs transmitting SRS than there are UEs being scheduled to in the subsequent downlink slots, the precoding selection will try to reduce interference to more UEs than necessary or to the wrong UEs. This also causes an unnecessary reduction in the received signal and may even result in a loss with RAIT. In reality there is typically a mix of different traffic types. UEs with traffic types like video, cloud gaming or download of large files will have a lot of data transmitted to them in the downlink over a longer period time. There are however also other traffic types like download of small files where a user every now and then downloads small files. If there is such a UE and SRS is transmitted to it in an uplink slot and then it turns out that it no longer has any data to be scheduled in an upcoming downlink slot, base stations in neighboring cells try to reduce interference towards this UE even though this is not necessary. In case there are many such UEs, it may have a large impact.

An object of embodiments herein is to improve the performance in a wireless communications network using SRS configurations.

According to an aspect of embodiments herein, the object is achieved by a method performed by a first network node. The method is for handling Sounding Reference Signal, SRS, configurations in a wireless communications network. The first network node is comprised in a group of network nodes together with one or more second network nodes. The first network node shares a set of SRS configurations in the group of network nodes. The set of SRS configurations comprises SRS resources to be used for SRS interference measurements. The set of SRS configurations is to be used by the network nodes in the group of network nodes to configure User Equipments, UEs. The UEs to be configured are UEs that are identified to be Downlink, DL, heavy traffic UEs comprising DL data, which has an estimated download time that exceeds a threshold. When the first network node obtains data to be transmitted to a first UE, it measures SRS interference. The SRS interference is measured on SRS transmitted by each respective UE identified to be a DL heavy traffic UE by the respective one or more second network nodes. The respective measuring of SRS interference is performed on resources according to an SRS configuration out of said shared SRS configuration set. The first network node then selects a precoder for the data to be transmitted to the first UE, based on the measured SRS interference.

According to an aspect of embodiments herein, the object is achieved by a method performed by a second network node. The method is for handling Sounding Reference Signal, SRS, configurations in a wireless communications network. The second network node is comprised in a group of network nodes together with at least a first network node. The second network node shares a set of SRS configurations in the group of network nodes. The set of SRS configurations comprises SRS resources to be used for SRS interference measurements. The set of SRS configurations is to be used by the network nodes in the group of network nodes, to configure User Equipments, UEs. The UEs to configure are UEs that are identified to be Downlink, DL, heavy traffic UEs comprising DL data, which has an estimated download time that exceeds a threshold. The second network node identifies a second UE that has DL data, which has an estimated download time that exceeds the threshold. The second network node sends an SRS configuration out of the SRS configuration set to the identified second UE. The SRS configuration enables the second UE to transmit SRS on resources according to the SRS configuration out of said shared SRS configuration set. The SRS configuration further enables the first network node to measure SRS interference on the SRS transmitted by the second UE, for selecting a precoder for data to be transmitted by the first network node to a first UE.

According to another aspect of embodiments herein, the object is achieved by a first network node configured to handle Sounding Reference Signal, SRS, configurations in a wireless communications network. The first network node is adapted to be comprised in a group of network nodes together with one or more second network nodes The first network node is further configured to:
Share a set of SRS configurations in the group of network nodes, which set of SRS configurations comprises SRS resources to be used for SRS interference measurements, which set of SRS configurations is to be used by the network nodes in the group of network nodes, to configure User Equipments, UEs, that are identified to be Downlink, DL, heavy traffic UEs comprising DL data, which has an estimated download time that exceeds a threshold,
when obtaining data to be transmitted to a first UE, measure SRS interference on SRS transmitted by each respective UE identified to be a DL heavy traffic UE by the respective one or more second network nodes, wherein the respective measuring of SRS interference is performed on resources according to an SRS configuration out of said shared SRS configuration set, and
select a precoder for the data to be transmitted to the first UE, based on the measured SRS interference.

According to another aspect of embodiments herein, the object is achieved by a second network node configured to handle Sounding Reference Signal, SRS, configurations in a wireless communications network. The second network node is adapted to be comprised in a group of network nodes together with at least a first network node. The second network node is further configured to:
Share a set of SRS configurations in the group of network nodes, which set of SRS configurations is adapted to comprise SRS resources to be used for SRS interference measurements, which set of SRS configurations is to be used by the network nodes in the group of network nodes, to configure User Equipments, UEs, that are identified to be Downlink, DL, heavy traffic UEs comprising DL data, which has an estimated download time that exceeds a threshold,
identify a second UE comprising DL data, which has an estimated download time that exceeds the threshold, and
send an SRS configuration out of the SRS configuration set to the identified second UE.

The SRS configuration is adapted to enable the second UE to transmit SRS on resources according to the SRS configuration out of said shared SRS configuration set, and the first network node to measure SRS interference on the SRS transmitted by the second UE, for selecting a precoder for data to be transmitted by the first network node to a first UE.

In this way, interference reduction may be done towards UEs that with a high probability gain from the interference reduction. This is since by using the method UEs have been identified which often have data to transmit and have made sure that SRS measurements are done only on SRS transmissions from these UEs. This leads to higher SINR for the UEs in the wireless communications network and higher performance in terms of reduced latency, higher bit rates and better capacity.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a first network node.

FIG. 3 is a flowchart depicting an embodiment of a method in a second network node.

FIG. 4 is a schematic block diagram illustrating embodiments of a wireless communications network.

FIG. 5 is a flowchart depicting a part of a method of embodiments herein.

FIG. 6 is a flowchart depicting another part of a method of embodiments herein.

FIG. 7 is a flowchart depicting a further part of a method of embodiments herein.

FIG. 8 is a schematic block diagram illustrating embodiments of a first network node.

FIG. 9 is a schematic block diagram illustrating embodiments of a second network node.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12-15 are flowcharts illustrating methods implemented in a communication system including a host computer, a base station, and a user equipment.

### DETAILED DESCRIPTION

Examples of embodiments herein provide a Method for improving SRS interference measurements e.g., for RAIT.

According to some examples of embodiments herein, all network nodes included in a group of network nodes, such as e.g., all base stations included in a coordination set of base stations, agree on a specific set of SRS configurations. The SRS configurations in the set of SRS configurations will only be configured in UEs which have a lot of downlink data over a longer period of time. The network nodes identify which UEs that have a lot of downlink data over a longer period of time and configure these users with an SRS configuration from this specific set of SRS configurations. Then a network node belonging to the group of network nodes measures SRS interference only on SRS resources belonging to this SRS configuration set, i.e. measures interference from the UEs which have a lot of downlink data over a longer period of time and selects a precoder for data to be transmitted to any other UE, based on the measured SRS interference.

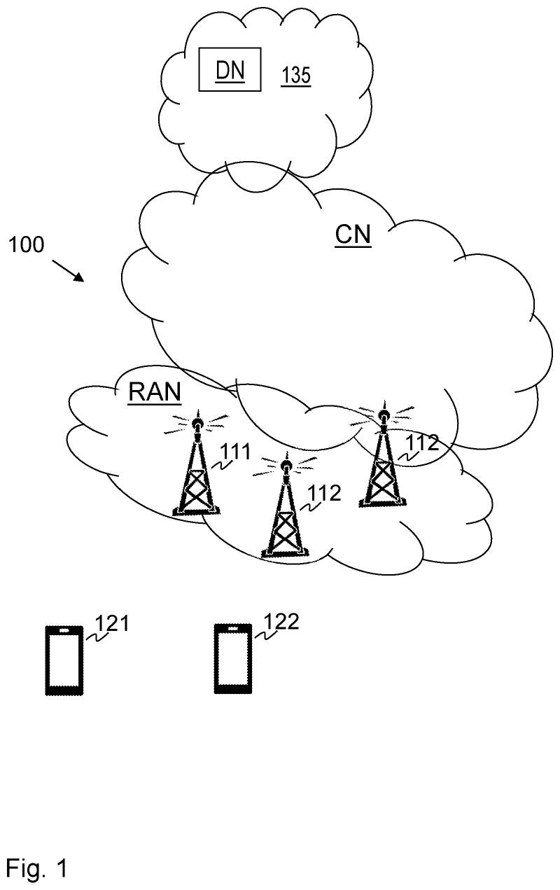

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a first network node 111, and one or more second network nodes 112 operate in the wireless communications network 100. Each respective network node 111, 112 e.g. provides a number of cells and may use these cells for communicating with UEs such as e.g. a first UE 121, and one or more second UEs 122. The respective network node 111, 112 may e.g. be a transmission and reception point e.g. a base station, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the respective network node 111, 112 depending e.g. on the radio access technology and terminology used.

UEs operate in the wireless communications network 100, such as e.g. the first UE 121, and the one or ore the second UEs 122. The respective UE 121, 122 UE may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the first base station 111. As an alternative, a Distributed Node (DN) and functionality, e.g. comprised in a cloud 135 as shown in FIG. 1, may be used for performing or partly performing the methods of embodiments herein.

Examples of embodiments herein e.g. provides:

An assigning of an SRS configuration from a specific set of SRS configurations to a second UE 122 having a lot of downlink data over a longer time.

An agreement between the network nodes in the group of network nodes 111, 112 to use this specific set of SRS configurations for UEs with a lot of downlink data over a longer time.

An identification of which UEs 122 that have a lot of downlink data over a longer time, and.

A measurement of SRS interference only on SRS resources belonging to the specific set of SRS configurations for selecting a precoder for data to be transmitted to any other UE, based on the measured SRS interference.

Advantages of embodiments herein e.g., comprise the following: According to embodiments herein, interference reduction is done towards UEs that with a high probability gain from interference reduction. This leads to higher SINR for the users in the network and higher performance in terms of reduced latency, higher bit rates and better capacity.

A number of embodiments will now be described, some of which may be seen as alternatives, while some may be used in combination.

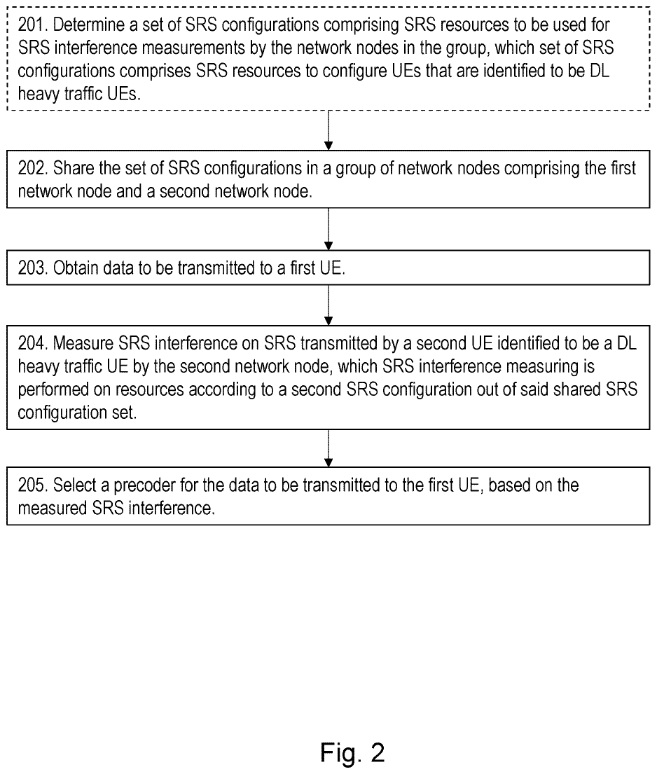

FIG. 2 shows exemplary embodiments of a method performed by the first network node 111. The method is for handling Sounding Reference Signal, SRS, configurations in a wireless communications network 100. The first network node 111 is comprised in a group of network nodes 111, 112 together with one or more second network nodes 112.

The method comprises the following actions, which actions may be taken in any suitable order. Optional actions are referred to as dashed boxes in FIG. 2.

### Action 201

In some embodiments, the first network node 111 determines the set of SRS configurations comprising SRS resources to be used for SRS interference.

### Action 202

The first network node 111 shares a set of SRS configurations in the group of network nodes 111, 112. The set of SRS configurations comprises SRS resources to be used for SRS interference measurements.

To share the set of SRS configurations in the group of network nodes 111, 112, may e.g. comprise that the first network node 111 sends the set of SRS configurations to the other network nodes in the group of network nodes 111, 112, e.g. when the first network node 111 has determined the set of SRS configurations, or in any other way obtained it.

As an alternative to share the set of SRS configurations in the group of network nodes 111, 112, may e.g. comprise that the first network node 111 receives the set of SRS configurations from another network node, e.g. one of the second network nodes 112, that shares it in the group of network nodes 111, 112, e.g. when one of the second network node 112 has determined the set of SRS configurations, or in any other way obtained it.

The SRS interference measurements may be related to RAIT. This means that the SRS interference measurements are being considered in the precoding selection.

The set of SRS configurations is to be used by the network nodes in the group of network nodes 111, 112. The set of SRS configurations is to be used to configure UEs that are identified to be DL heavy traffic UEs. These UEs comprise DL data which has an estimated download time that exceeds a threshold.

The set of SRS configurations may e.g., comprise any one or more out of: One or several specific SRS combs, and one or several specific time slots. SRS combs when used herein may e.g., means which parts of the SRS resources in the frequency band to use.

The shared set of SRS configurations in the group of network nodes 111, 112, may e.g., be an agreement between the network nodes in the group of network nodes 111, 112, agreed via any one out of: a proprietary coordination interface between the network nodes in the group of network nodes 111, 112, or a standardized messages sent to each of the network nodes in the group of network nodes 111, 112.

### Action 203

The first network node 111 obtains data to be transmitted to the first UE 121.

### Action 204

When the first network node 111 has obtained data to be transmitted to the first UE 121, it measures SRS interference. The SRS interference is measured on SRS transmitted by each respective UE 122 identified to be a DL heavy traffic UE by the respective one or more second network nodes 112. The respective measuring of SRS interference is performed on resources according to a respective SRS configuration out of said shared SRS configuration set.

### Action 205

The first network node 111 then selects a precoder for the data to be transmitted to the first UE 121, based on the measured SRS interference.

In this way the interference that the transmission from the first network node 111 causes to UEs in neighboring cells is reduced towards UEs that with a high probability will benefit from the interference reduction.

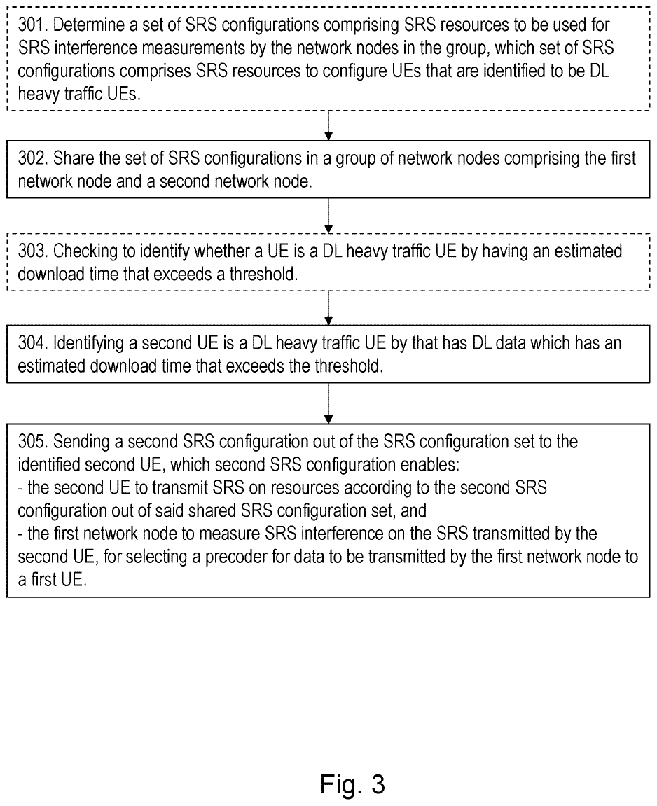

FIG. 3 shows examples of embodiments of a method performed by method performed by a second network node 112. The method is for handling Sounding Reference Signal, SRS, configurations in a wireless communications network 100, wherein the second network node 112 is comprised in a group of network nodes 111, 112 together with at least a first network node 111.

The method comprises the following actions, which actions may be taken in any suitable order. Optional actions are referred to as dashed boxes in FIG. 3.

### Action 301

In some embodiments, the second network node 112 determines the set of SRS configurations comprising SRS resources to be used for SRS interference.

### Action 302

The second network node 112 shares the set of SRS configurations in the group of network nodes 111, 112. The set of SRS configurations comprises SRS resources to be used for SRS interference measurements. The SRS interference measurements may e.g., be related to RAIT.

Similar as hinted above, to share the set of SRS configurations in the group of network nodes 111, 112, may e.g. comprise that the second network node 112 sends the set of SRS configurations to the other network nodes in the group of network nodes 111, 112, e.g. when the second network node 112 has determined the set of SRS configurations, or in any other way obtained it.

As an alternative to share the set of SRS configurations in the group of network nodes 111, 112, may e.g. comprise that the second network node 112 receives the set of SRS configurations from another network node, e.g. the first network nodes 111, that shares it in the group of network nodes 111, 112, e.g. when the first network node 111 has determined the set of SRS configurations, or in any other way obtained it.

The set of SRS configurations is to be used by the network nodes in the group of network nodes 111, 112. The set of SRS configurations is to be used to configure UEs that are identified to be DL heavy traffic UEs. These DL heavy traffic UEs comprises DL data, which has an estimated download time that exceeds a threshold.

The set of SRS configurations may e.g., comprise any one or more out of: One or several specific SRS combs, and one or several specific time slots.

The shared set of SRS configurations in the group of network nodes 111, 112, may be an agreement between the network nodes in the group of network nodes 111, 112, agreed via any one out of: A proprietary coordination interface between the network nodes in the group of network nodes 111, 112, or standardized messages sent to each of the network nodes in the group of network nodes 111, 112.

### Action 303

The second network node 112 may check if it can find any DL heavy traffic UE, in that case that DL heavy traffic UE will be configured with an SRS configuration out of the set of SRS configurations. In some embodiments, the second network node 112 checks to identify whether a UE is a DL heavy traffic UE comprising DL data, which has an estimated download time that exceeds a threshold. This may performed at different occasions, e.g., when any one or more out of:
A UE is connecting to the network node 111,
any of the UEs already connected to the network node 111 have become a DL heavy traffic UE and change its SRS configuration if needed, and
any of the UEs already connected to the network node 111 have stopped being a DL heavy traffic UE and change its SRS configuration if needed.

### Action 304

The second network node 112 identifies a UE, the second UE 122, that has DL data which has an estimated download time that exceeds the threshold.

The identifying that the second UE 122 is a DL heavy traffic UE, may e.g., be performed by any one out of:
Setting up specific radio bearers for UEs that that has DL data, which has an estimated download time that exceeds a threshold,
observing characteristics of data traffic in DL transmissions to UEs over a period of time.

### Action 305

The second network node 112 then sends an SRS configuration out of the SRS configuration set to the identified second UE 122. The SRS configuration enables:

The SRS configuration enables the second UE 122 to transmit SRS on resources according to the SRS configuration out of said shared SRS configuration set, and

The SRS configuration further enables the first network node 111 to measure SRS interference on the SRS transmitted by the second UE 122, for selecting a precoder for data to be transmitted by the first network node 111 to the first UE 121.

Embodiments herein such as the embodiments mentioned above will now be further described and exemplified. The text below is applicable to and may be combined with any suitable embodiment described above.

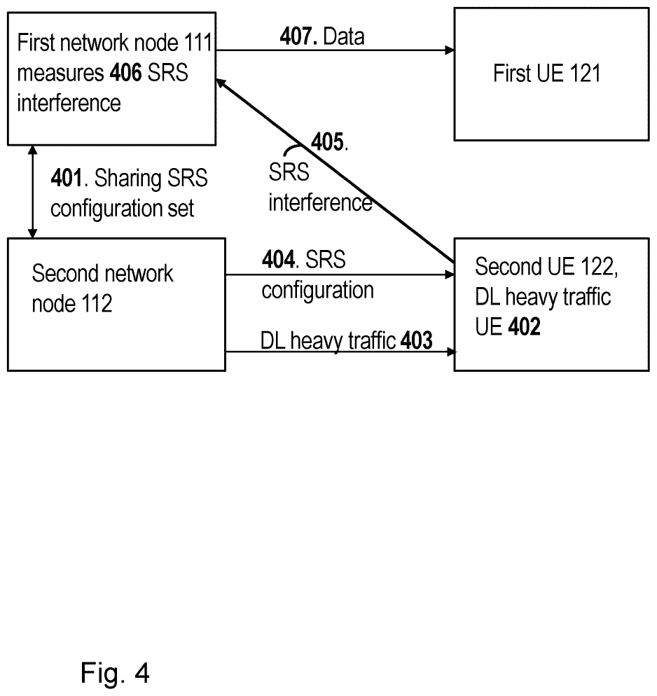

FIG. 4 depicts an example scenario of embodiments herein.

The first network node 111 and second network node 112 in the group of network nodes 111, 112 share 401 a set of SRS configurations. This relates to and may be combined with Actions 202 and 302 as described above.

The second network node 112 identifies the second UE 122 as a DL heavy traffic UE 402 that has DL data 403 which has an estimated download time that exceeds the threshold. This relates to and may be combined with Action 304 as described above.

The second network node 112 sends 404 an SRS configuration out of the SRS configuration set to the identified second UE 122. This relates to and may be combined with Action 305 as described above.

The second UE 122 transmits 405 SRS on resources according to the SRS configuration out of said shared SRS configuration set.

When the first network node 111 obtains data to be transmitted to a first UE 121, it measures 406 the SRS interference on SRS transmitted 405 by each respective UE, including the second UE 122, which has been identified to be a DL heavy traffic UE. This relates to and may be combined with Action 203 and 204 as described above.

The first network node 111 then selects a precoder for the data to be transmitted to the first UE 121, based on the measured SRS interference, and sends 406 the data to the first UE 121, using the selected precoder. This relates to and may be combined with Action 205 as described above.

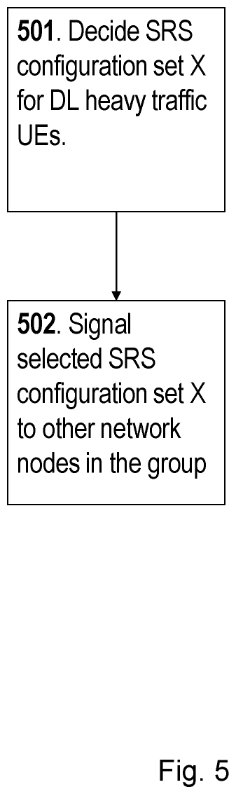

FIG. 5 depicts a first part of the method according to an example of embodiments herein. In this first part, the network nodes, such as the first network node 111 and the second network node 112 in the group of network nodes 111, 112, agree and decide 501 on which set of SRS configurations X to use for the UEs which have DL data over a longer period of time. These UEs are referred to as downlink heavy traffic users. In some embodiments this SRS configuration set X comprises one or several specific SRS combs. In some other embodiments, the SRS configuration set X is one or several specific time slots. In some embodiments the agreement in the group of network nodes 111, 112 is done using a proprietary coordination interface. In some other embodiments it is done using a standardized message. The selected SRS configuration set X is signaled 502 to other network nodes in the group.

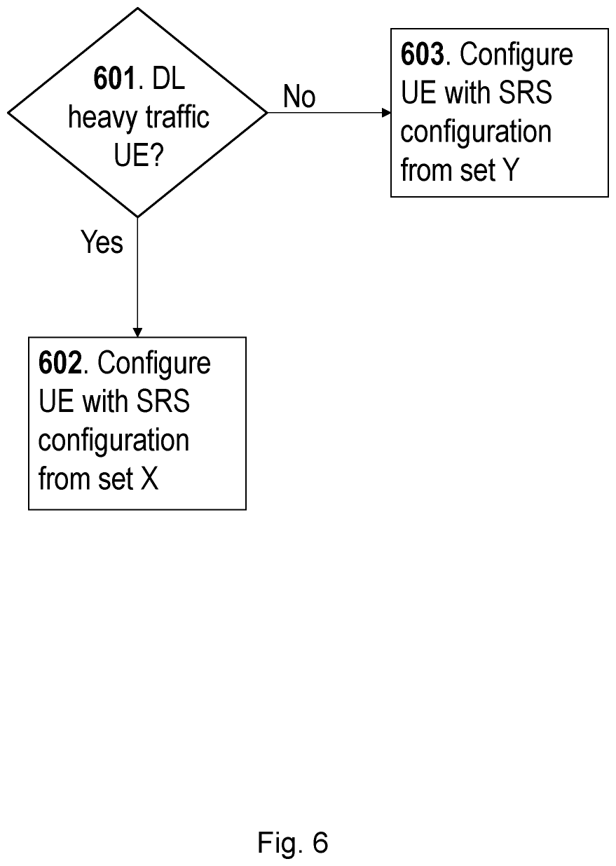

FIG. 6 depicts a second part of the method according to an example of embodiments herein. In this second part, the second network node 112 and the other network nodes in the group, identifies 601 if new UEs connecting to the base station are downlink heavy traffic UEs and if Yes, configure 602 these UEs with an SRS configuration from set X. If No, they are not downlink heavy traffic UEs they are configured 603 with an SRS configuration from another configuration set Y. The network nodes such as the second network node 112 may also continuously check if any of the UEs already connected to the network nodes, such as the second network node 112, have become DL heavy traffic UEs or have stopped being DL heavy traffic UEs and change their SRS configuration if needed. In some embodiments the identification of which UEs that have a lot of data over a longer time period is done by setting up a specific radio bearer for these UEs. In some other embodiments it may be done by observing characteristics of the traffic over a period of time.

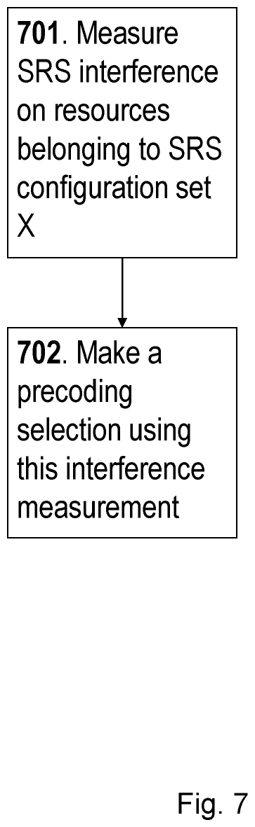

FIG. 7 depicts a third part of the method according to an example of embodiments herein. In this third part, the network nodes such as the first network node 111 measure 701 the SRS interference on the resources belonging to SRS configuration set X and make a precoding selection 702 for a data transmission to any UE such as e.g. the first UE 121, based on these SRS interference measurements.

To perform the method actions above, the first network node 111 is configured to handle SRS configurations in the wireless communications network 100. The first network node 111 is adapted to be comprised in the group of network nodes 111, 112 together with the one or more second network nodes 112.

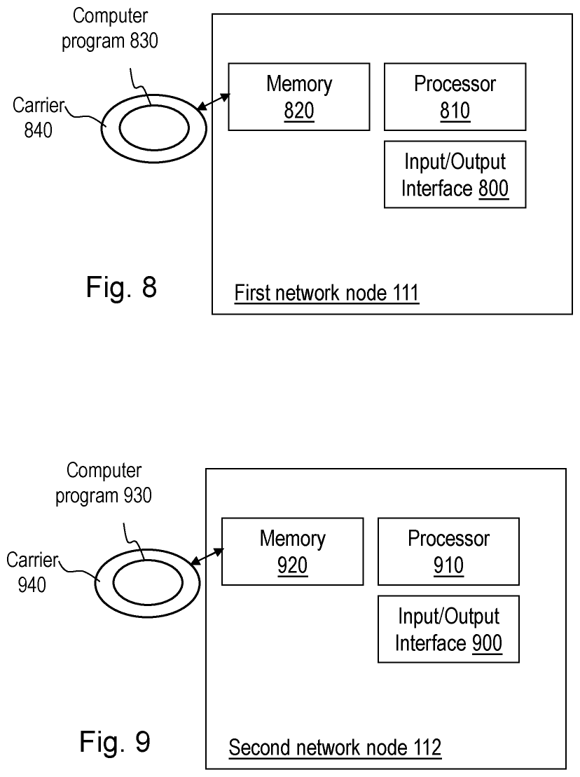

The first network node 111 may comprise an arrangement depicted in FIG. 8. The first network node 111 may comprise an input and output interface 800 configured to communicate in the wireless communications network 100, e.g., with the second network node 112 and the first UE 121. The input and output interface 800 may comprise a wireless receiver not shown and a wireless transmitter not shown.

The first network node 111 is further configured to:
Share a set of SRS configurations in the group of network nodes 111, 112, which set of SRS configurations comprises SRS resources to be used for SRS interference measurements. The set of SRS configurations is to be used by the network nodes in the group of network nodes 111, 112, to configure UEs that are identified to be DL heavy traffic UEs comprising DL data, which has an estimated download time that exceeds a threshold.
When obtaining data to be transmitted to a first UE 121, measure SRS interference on SRS transmitted by each respective UE 122 identified to be a DL heavy traffic UE by the respective one or more second network nodes 112. The respective measuring of SRS interference is performed on resources according to an SRS configuration out of said shared SRS configuration set.
Select a precoder for the data to be transmitted to the first UE 121, based on the measured SRS interference.

The SRS interference measurements may be related to RAIT.

The first network node 111 may further be configured to determine the set of SRS configurations comprising SRS resources to be used for SRS interference.

The set of SRS configurations may be adapted to comprise any one or more out of one or several specific SRS, and one or several specific time slots.

In some embodiments, the shared set of SRS configurations in the group of network nodes 111, 112, is adapted to be an agreement between the network nodes in the group of network nodes 111, 112. It may be agreed via any one out of a proprietary coordination interface between the network nodes in the group of network nodes 111, 112, or standardized messages sent to each of the network nodes in the group of network nodes 111, 112.

To perform the method actions above, the second network node 112 is configured to handle SRS configurations in the wireless communications network 100. The second network node 112 is adapted to be comprised in a group of network nodes 111, 112 together with at least a first network node 111.

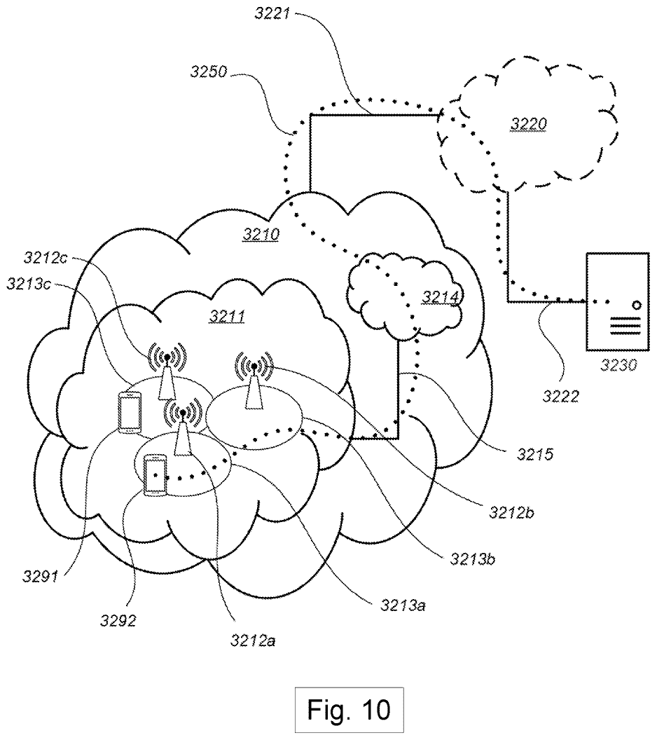

The second network node 112 may comprise an arrangement depicted in FIG. 9. The second network node 112 may comprise an input and output interface 900 configured to communicate in the wireless communications network 100, e.g., with the first network node 111 and the second UE 122. The input and output interface 800 may comprise a wireless receiver not shown and a wireless transmitter not shown.

The second network node 112 further is configured to:
Share a set of SRS configurations in the group of network nodes 111, 112, which set of SRS configurations is adapted to comprise SRS resources to be used for SRS interference measurements. The set of SRS configurations is to be used by the network nodes in the group of network nodes 111, 112, to configure User Equipments, UEs, that are identified to be DL heavy traffic UEs comprising DL data, which has an estimated download time that exceeds a threshold.
Identify a second UE 122 comprising DL data, which has an estimated download time that exceeds the threshold.
Send an SRS configuration out of the SRS configuration set to the identified second UE 122.

The SRS configuration is adapted to enable:
The second UE 122 to transmit SRS on resources according to the SRS configuration out of said shared SRS configuration set, and
the first network node 111 to measure SRS interference on the SRS transmitted by the second UE 122, for selecting a precoder for data to be transmitted by the first network node 111 to a first UE 121.

The SRS interference measurements may be related to RAIT.

The second network node 112 may further being configured to determine the set of SRS configurations comprising SRS resources to be used for SRS interference.

25. The set of SRS configurations may be adapted to comprise any one or more out of one or several specific SRS combs, and one or several specific time slots.

The shared set of SRS configurations in the group of network nodes 111, 112, may be an agreement between the network nodes in the group of network nodes 111, 112, agreed via any one out of:
a proprietary coordination interface between the network nodes in the group of network nodes 111, 112,
standardized messages sent to each of the network nodes in the group of network nodes 111, 112.

The second network node 112 may further being configured to check to identify whether a UE is a DL heavy traffic UE comprising DL data, which has an estimated download time that exceeds a threshold, when any one or more out of:
A UE is connecting to the network node 111,
any of the UEs already connected to the network node 111 have become a DL heavy traffic UE and change its SRS configuration if needed,
any of the UEs already connected to the network node 111 have stopped being a DL heavy traffic UE and change its SRS configuration if needed.

The second network node 112 may further be configured to the identify that the second UE 122 is a DL heavy traffic UE by any one or more out of:
Setting up specific radio bearers for UEs that that has DL data, which has an estimated download time that exceeds a threshold, and
observing characteristics of data traffic in DL transmissions to UEs over a period of time.

The embodiments herein may be implemented through a respective processor or one or more processors, such as the respective processor 810 of a processing circuitry in the first network node 111 depicted in FIG. 8, and processor 910 of a processing circuitry in the second network node 112 depicted in FIG. 9 together with respective computer program code for performing the functions and actions of the embodiments herein. The program code mentioned above may also be provided as a computer program product, for instance in the form of a data carrier carrying computer program code for performing the embodiments herein when being loaded into the respective first network node 111 and second network node 112. One such carrier may be in the form of a CD ROM disc. It is however feasible with other data carriers such as a memory stick. The computer program code may furthermore be provided as pure program code on a server and downloaded to the respective first network node 111 and second network node 112.

The first network node 111 and second network node 112 may further comprise a respective memory 820 and memory 920 comprising one or more memory units. The respective memory 820 and memory 920 comprises instructions executable by the processor in the respective first network node 111 and second network node 112. The respective memory 820 and memory 920 are arranged to be used to store e.g., information, indications, data, configurations, iterations, communication data, and applications to perform the methods herein when being executed in the respective first network node 111 and second network node 112.

In some embodiments, a respective computer program 830 and computer program 930 comprises instructions, which when executed by the respective at least one processor 810 and processor 910, cause the at least one processor of respective first network node 111 and second network node 112 to perform the actions above.

In some embodiments, a respective carrier 840 and carrier 940 comprises the respective computer program 830 and computer program 930, wherein the respective carrier 840 and carrier 940 is one of an electronic signal, an optical signal, an electromagnetic signal, a magnetic signal, an electric signal, a radio signal, a microwave signal, or a computer-readable storage medium.

Those skilled in the art will appreciate that units in the respective first network node 111 and second network node 112 described above may refer to a combination of analog and digital circuits, and/or one or more processors configured with software and/or firmware, e.g. stored in the respective BS 110 and UE 120, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

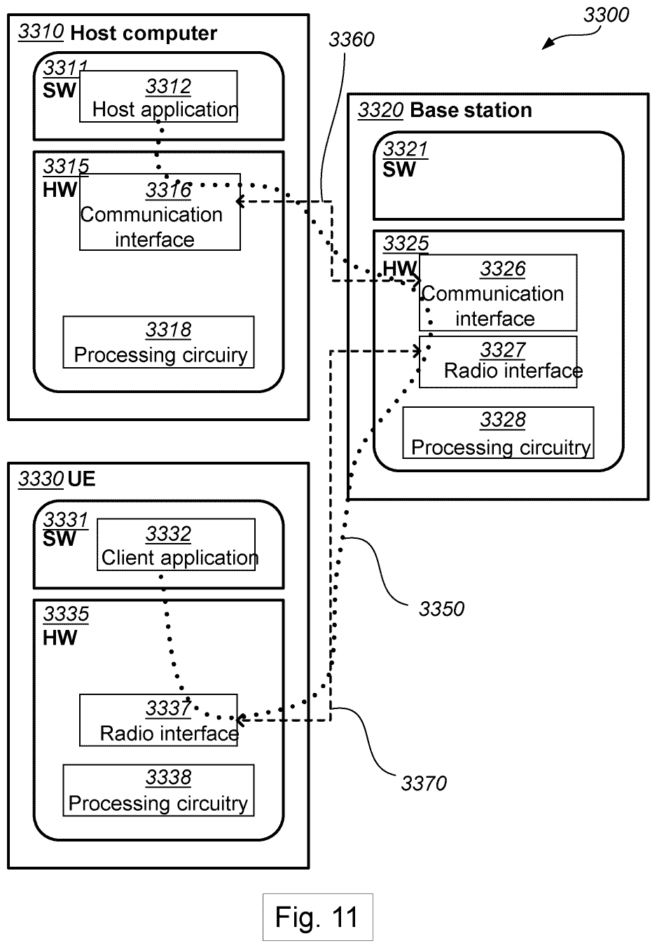

With reference to FIG. 10, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the BS 110, such as AP STAs NBs, eNBs, gNBs or other types of wireless access points, each defining a corresponding coverage area 3213a, 3213b, 3213c. Each base station 3212a, 3212b, 3212c, e.g. radio network nodes 141, 142, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

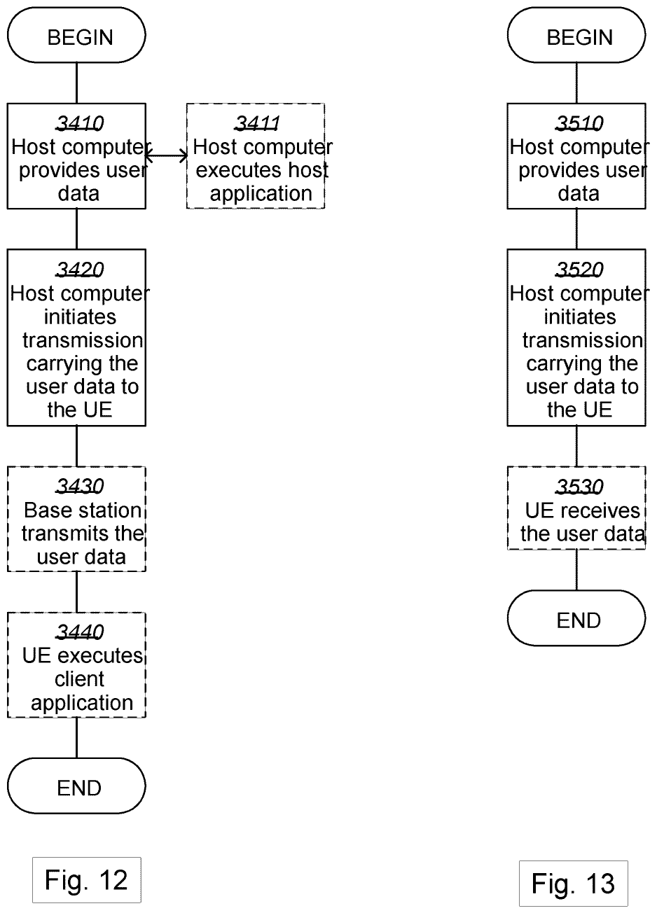

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

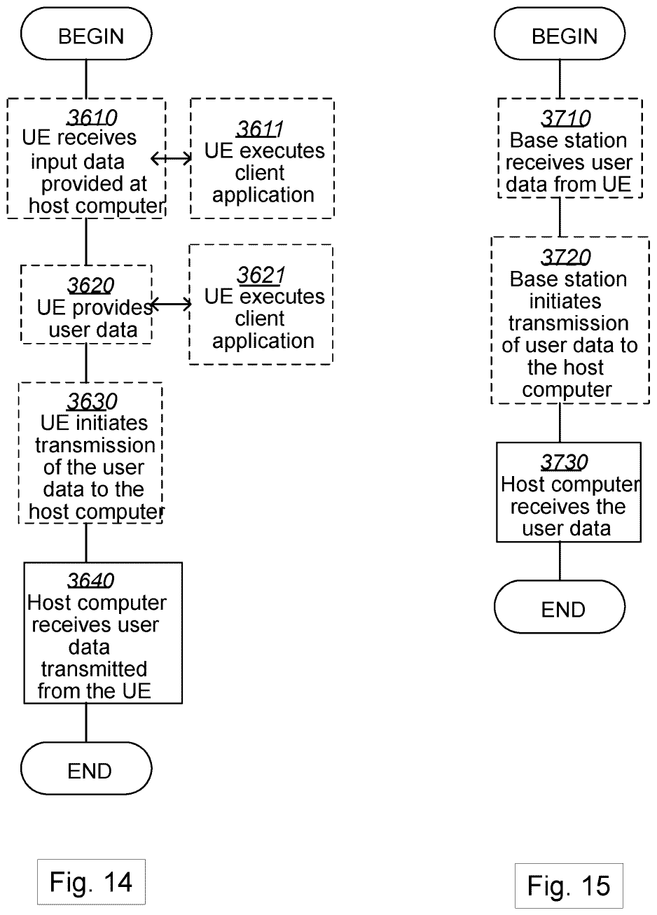

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 12 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 13 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 14 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 2610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 15 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a first network node for handling Sounding Reference Signal, SRS, configurations in a wireless communications network, wherein the first network node is comprised in a group of network nodes together with one or more second network nodes, the method comprising:
sharing a set of SRS configurations in the group of network nodes, which set of SRS configurations comprises SRS resources to be used for SRS interference measurements, which set of SRS configurations is to be used by the network nodes in the group of network nodes, to configure User Equipments, UEs, that are identified to be Downlink, DL, heavy traffic UEs comprising DL data, which has an estimated download time that exceeds a threshold;
when obtaining data to be transmitted to a first UE, measuring SRS interference on SRS transmitted by each respective UE identified to be a DL heavy traffic UE by the respective one or more second network nodes, which respective measuring of SRS interference is performed on resources according to an SRS configuration out of said shared SRS configuration set; and
selecting a precoder for the data to be transmitted to the first UE, based on the measured SRS interference.

2. The method according to claim 1, wherein the SRS interference measurements are related to Reciprocity-Assisted Interference-aware Transmission, RAIT.

3. The method according to claim 1, further comprising:
determining the set of SRS configurations comprising SRS resources to be used for SRS interference.

4. The method according to claim 1, wherein the set of SRS configurations comprises any one or more out of:
one or several specific SRS combs; and
one or several specific time slots.

5. The method according to claim 1, wherein the shared set of SRS configurations in the group of network nodes, is an agreement between the network nodes in the group of network nodes, agreed via any one out of:
a proprietary coordination interface between the network nodes in the group of network nodes; or
standardized messages sent to each of the network nodes in the group of network nodes.

6-7. (canceled)

8. A method performed by a second network node for handling Sounding Reference Signal, SRS, configurations in a wireless communications network, wherein the second network node is comprised in a group of network nodes together with at least a first network node, the method comprising:
sharing a set of SRS configurations in the group of network nodes, which set of SRS configurations comprises SRS resources to be used for SRS interference measurements, which set of SRS configurations is to be used by the network nodes in the group of network nodes, to configure User Equipments, UEs, that are identified to be Downlink, DL, heavy traffic UEs comprising DL data, which has an estimated download time that exceeds a threshold;
identifying a second UE that has DL data, which has an estimated download time that exceeds the threshold; and
sending an SRS configuration out of the set of SRS configurations to the identified second UE;
which the SRS configuration enables:
the second UE to transmit SRS on resources according to the SRS configuration out of the shared set of SRS configurations, and
the first network node to measure SRS interference on the SRS transmitted by the second UE, for selecting a precoder for data to be transmitted by the first network node to a first UE.

9. The method according to claim 8, wherein the SRS interference measurements are related to Reciprocity-Assisted Interference-aware Transmission, RAIT.

10. The method according to claim 8, further comprising:
determining the set of SRS configurations comprising SRS resources to be used for SRS interference; and
wherein the set of SRS configurations comprises any one or more out of:
one or several specific SRS combs, and
one or several specific time slots.

11. (canceled)

12. The method according to claim 8, wherein the shared set of SRS configurations in the group of network nodes, is an agreement between the network nodes in the group of network nodes, agreed via any one out of:
a proprietary coordination interface between the network nodes in the group of network nodes; or
standardized messages sent to each of the network nodes in the group of network nodes.

13. The method according to claim 8, further comprising:
checking to identify whether a UE is a DL heavy traffic UE comprising DL data, which has an estimated download time that exceeds a threshold, when any one or more out of:
a UE is connecting to the network node,
any of the UEs already connected to the network node have become a DL heavy traffic UE and change its SRS configuration if needed, and
any of the UEs already connected to the network node have stopped being a DL heavy traffic UE and change its SRS configuration if needed.

14. The method according to claim 8, wherein the identifying that the second UE is a DL heavy traffic UE, is performed by any one out of:
setting up specific radio bearers for UEs that that has DL data, which has an estimated download time that exceeds a threshold; and
observing characteristics of data traffic in DL transmissions to UEs over a period of time.

15-16. (canceled)

17. A first network node configured to handle Sounding Reference Signal, SRS, configurations in a wireless communications network, wherein the first network node is adapted to be comprised in a group of network nodes together with one or more second network nodes, the first network node further being configured to:
share a set of SRS configurations in the group of network nodes, which set of SRS configurations comprises SRS resources to be used for SRS interference measurements, which set of SRS configurations is to be used by the network nodes in the group of network nodes, to configure User Equipments, UEs, that are identified to be Downlink, DL, heavy traffic UEs comprising DL data, which has an estimated download time that exceeds a threshold;
when obtaining data to be transmitted to a first UE, measure SRS interference on SRS transmitted by each respective UE identified to be a DL heavy traffic UE by the respective one or more second network nodes, wherein the respective measuring of SRS interference is performed on resources according to an SRS configuration out of said shared SRS configuration set; and
select a precoder for the data to be transmitted to the first UE, based on the measured SRS interference.

18-28. (canceled)

29. The first network node according to claim 17, wherein said network node is configured to perform the steps according to the method of claim 1.
